(19) United States
(12) Patent Application Publication
(10) Pub. No.: US 2025/0210050 A1
(43) Pub. Date: Jun. 26, 2025

(54) Bandwidth Reduction for Convolution Reverb

(71) Applicant: Sony Interactive Entertainment Inc., Tokyo (JP)

(72) Inventor: Jeppe Oland, San Francisco, CA (US)

(21) Appl. No.: 18/977,645

(22) Filed: Dec. 11, 2024

Related U.S. Application Data
(60) Provisional application No. 63/612,962, filed on Dec. 20, 2023.

(51) Int. Cl. G10L 19/008

(52) U.S. Cl. CPC G10L 19/008

(57) ABSTRACT

Frequency spectrum data of a segment of an input audio signal is converted from complex number form having a high bit count real and imaginary parts to polar coordinate form having a lower bit count angles and amplitudes. The frequency spectrum of the segment of the input audio signal is stored in the polar coordinate form. Storing the frequency spectrum of the segment of the input signal in polar coordinate form requires fewer bits than storing the frequency spectrum data of the segment of the input signal in complex number form.

### PRIORITY

This application claims the benefit of priority to co-pending provisional application Ser. No. 63/612,962, filed 20 Dec. 2023, the entire disclosures of which are incorporated herein by reference.

### FIELD OF THE DISCLOSURE

Aspects of the present disclosure relate to audio compression specifically aspects of the present disclosure relate to compression of impulse response signals for convolutional reverberation audio.

### BACKGROUND OF THE DISCLOSURE

Convolution of input signals such as impulse response functions (impulse response signals are also referred to herein as reverberations or reverb) with other input signals has a wide variety of applications, including, e.g., audio and video signal processing, sonar and radar, and general digital signal processing (DSP) applications. One such example is the convolution of audio signals to simulate the acoustic effect of an environment, whereby a source signal may be convolved with a finite impulse response (FIR) function that models the acoustic response of the environment. A practical application of such audio signal convolution is the real-time synthesis of sounds in a simulation, such as a video game virtual environment, in which a pre-computed impulse response function that models the acoustic characteristics of a virtual room may be convolved with an input source signal in real-time to simulate the virtual environment's acoustics. A variety of conventional techniques are available for performing convolution of such signals.

One such technique is direct convolution in the time domain of the functions corresponding to the input signal and impulse response filter. However, the computational cost of performing such convolution can be very high and the computation time for performing such operations increases linearly with filter length (i.e., t∝N², where t is the computation time and N is the filter length or number of sampled points in the impulse response function). As a result, direct convolution in the time domain is unsuitable for many real-time applications, particularly when the impulse response function is of relatively long duration.

Considering the drawbacks associated with direct convolution, a variety of frequency domain techniques have been proposed which involve generating the frequency spectra of the time domain signals in order to take advantage of the concept that convolution in the time domain is replaced with point-wise multiplication in the frequency domain. The computation time scales logarithmically with filter length (i.e., t∝N log₂ N) rather than linearly, thereby providing a significant computational cost advantage over direct time domain techniques if the sample size is large enough.

Frequency domain convolution techniques typically involve a digitally sampled impulse response function, which may be pre-computed, a digitally sampled input signal, and conversion of the sampled signals into the frequency domain with a discrete Fourier transform (DFT). The DFT is typically performed by using a Fast Fourier Transform (FFT) algorithm on the time domain input signal and impulse response, and each segment of the signal and impulse response may be zero-padded to avoid circular convolution. Point-wise multiplication of the complex valued input signal and impulse response spectra is performed, and the resulting product is converted back to the time domain by an inverse Fast Fourier Transform (IFFT) to generate the desired convolved and filtered signal as a function of time.

An issue with the current techniques is that impulse responses currently may be stored as frequency domain spectra using high bit count complex numbers. These high bit count complex numbers have a real part and imaginary part each of which may be represented by a floating point (or integer) of 32-bit precision. Typically, this may be reduced to a 16-bit representation without excessive distortion. These complex numbers are required to have a high bit count for both real and imaginary parts to represent the sound without excessive distortion.

It is within this context that aspects of the present disclosure arise.

### BRIEF DESCRIPTION OF THE DRAWINGS

The teachings of the present disclosure can be readily understood by considering the following detailed description in conjunction with the accompanying drawings, in which:

FIG. 1 is a diagram showing an example of conversion of a complex number to polar coordinates according to aspects of the present disclosure.

FIG. 2 is a flow diagram depicting a method for compression of input signal data according to aspects of the present disclosure.

FIG. 3 graphically depicts an example method for compression of input signal data according to aspects of the present disclosure.

FIG. 4A is a signal flow diagram depicting in detail the method for compression of input signal data according to aspects of the present disclosure.

FIG. 4B is a signal flow diagram depicting a method for convolution of compressed input signal data with another input signal according to aspects of the present disclosure.

FIG. 4C is a signal flow diagram depicting a method for convolution of compressed input signal data with the data of another compressed input signal according to aspects of the present disclosure.

FIG. 5 is a block system diagram depicting a system for carrying out the method of compression of input signals according to aspects of the present disclosure.

### DESCRIPTION OF THE SPECIFIC EMBODIMENTS

Although the following detailed description contains many specific details for the purposes of illustration, anyone of ordinary skill in the art will appreciate that many variations and alterations to the following details are within the scope of the invention. Accordingly, examples of embodiments of the invention described below are set forth without any loss of generality to, and without imposing limitations upon, the claimed invention.

Input signals such as impulse response functions are often stored as transformed spectra data in the frequency domain for ease of use in convolutional operations. The spectra data is comprised of complex numbers for each frequency bin represented as for example and without limitation 32-bit or 16-bit floating point numbers or integers. Each complex number includes two parts, a real part, and an imaginary part; each part may be represented by a separate 16-bit or 32-bit floating point number or integer. Representing these complex numbers requires a lot of data, which makes transmission of these impulse response functions over a network time consuming and bandwidth intensive. Relatedly, processing operations on the input signals must read the spectra data from memory continuously and since these processing operations are typically simple the performance of these processing operations is limited by memory bandwidth. Additionally, the size of the spectra restricts the amount of data that may be stored on devices with limited storage space. Thus, it has been recognized by the Applicants that the size of transformed input signals for storage is a problem to be solved.

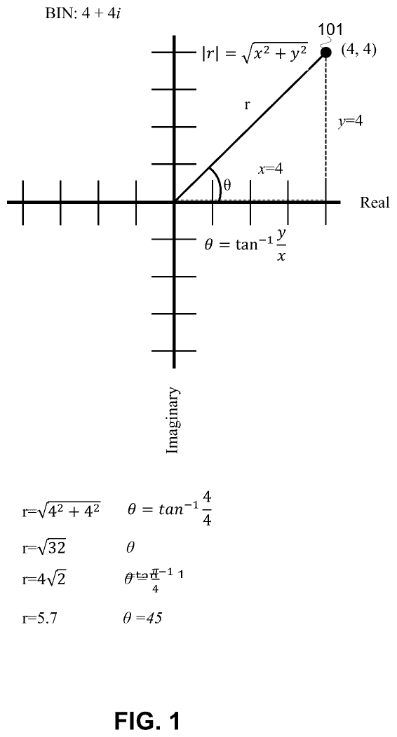

There are two relevant ways to express input signals in the frequency domain according to aspects of the present disclosure. The first way to express frequency domain signals is in complex number form with a real and imaginary part. The second way is to express the signals in the frequency domain as polar coordinates in terms of an angle and an amplitude. FIG. 1 graphically illustrates an example of conversion of a complex frequency bin value to polar coordinates. In the example shown in FIG. 1, a frequency bin has a real part value of 4 and an imaginary part value of 4i. Conversion to polar coordinates can be shown graphically as mapping the real and imaginary parts of the complex number to a coordinate grid with the Y axis representing the imaginary part and the X axis representing the real part. Thus, the frequency bin represented by complex number 4, 4i is mapped to the positive section of the grid 101 with location (4,4). The amplitude of the frequency bin in polar form may be thought of as the distance of the location of the frequency bin in the coordinate grid from origin and thus may be determined by the distance formula: |r|=\sqrt{X²+Y²}. In this example the amplitude of this frequency bin is \sqrt{4²+4²}=\sqrt{32} or roughly 5.7. In polar coordinate form the angle θ is the angle of a circle inscribed around origin passing through the frequency bin location 101 on the coordinate grid. It also may be considered the angle of hypotenuse of a 90-degree triangle formed between the frequency bin location 101 and origin. Thus, to find the angle θ the inverse trigonometric function, arctangent may be used. Arctangent here is applied to find the angle from origin using the equation

$$θ = {tan}^{- 1} \frac{y}{x}$$

As applied to the Example shown

$$θ = 45 ° = \frac{π}{4} = {tan}^{- 1} \frac{4}{4} .$$

A feature recognized by the Applicants here, is that polar form represents a number form that may be compressed more than the same number in complex number form without overly degrading the quality of compressed spectra and/or audio when converted back to the time domain and played through a speaker. For example, and without limitation, it has been found that the angle values and amplitude values may be converted to 8-bit or 6-bit integer angles and 8-bit amplitudes without an excessive perceptible loss in audio quality.

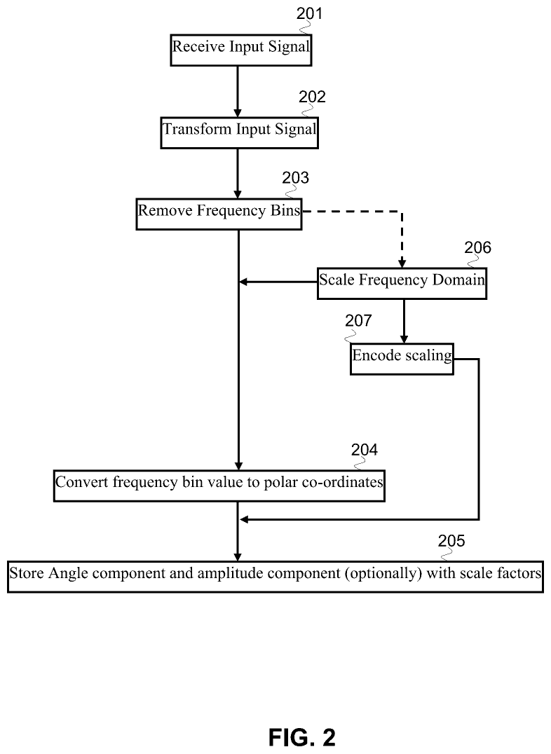

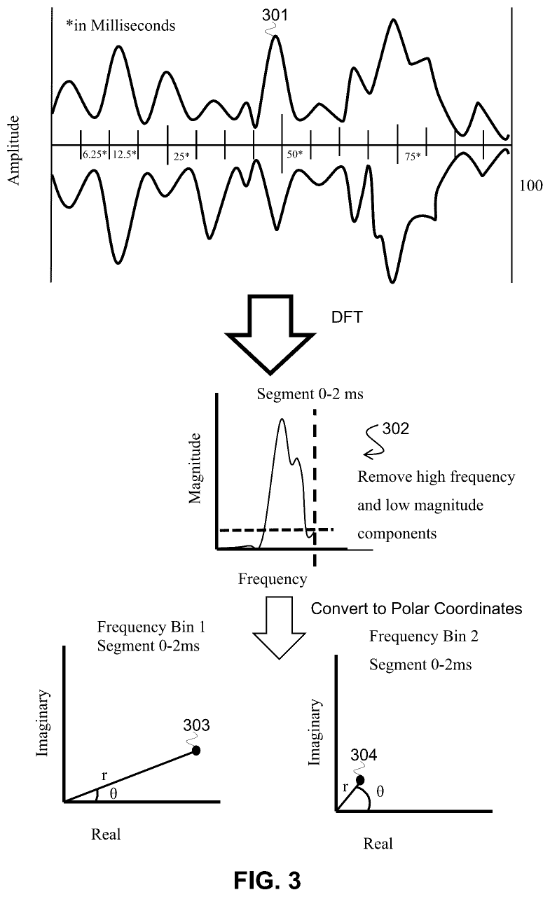

While conversion of complex numbers for frequency spectra to polar form represents one improvement for spectra file size compression, other compression techniques may also be applied as discussed herein to realize at least a fifty percent reduction in file size as compared to prior art frequency spectra. FIG. 2 is a flow diagram depicting the method for compression of input signal data according to aspects of the present disclosure. FIG. 3 graphically depicts an example method for compression of input signal data according to aspects of the present disclosure.

Initially, an input signal is received, as indicated at 201. The input signal may be an audio signal for example and without limitation the input signal may be a music signal, room impulse response signal, conversational audio signal, data signal etc. The input signal may be received from a recording device for example and without limitation one or more microphones, signal generators (e.g. electric keyboard, sine wave generators, etc.), playback devices (e.g. cassette tape players, record player, compact disk player, etc.), storage devices (e.g. hard drives, Solid state Drives, Flash Storage etc.), networks etc. The input signal may be a continuous signal in the time domain such as spectrum 301 shown in FIG. 3 or alternatively may be a discrete signal sampled at a sampling interval for example and without limitation 44.1 kilo Hertz (kHz). Next the input signal is segmented (e.g., via a sliding window) and the segments are transformed from the time domain to the frequency domain at 202 generating a frequency domain spectrum of segments of the input signal. The input signal may be transformed via DFT as discussed above. It should be noted that in some implementations the input signal data may be received already as frequency domain spectrum data of segments of the input signal. In such implementations the transformation step may be skipped, and the method may be continued.

Once segments of the input signal are in the frequency domain the high frequency bins and low signal amplitude bins may be removed at 203 creating a truncated frequency spectrum data of segments of the input signal. Here the high frequency bins correspond to frequencies that are outside of the range of normal human hearing. Low signal amplitude bins may have frequencies within the human range of hearing but because the amplitude of the signal in those bins is low there will be no perceptible loss in quality as the average listener is unlikely to hear such quiet components. For example and without limitation, the high frequency bins may be bins corresponding to frequencies greater than 20 kHz or greater than 40 kHz. Discarding the information in the high frequency bins may not affect the perceptible quality of the audio created by the transformed signal because the high frequency bins are outside of the range of normal human hearing. As shown in FIG. 3 each transformed segment 302 represents a frequency domain spectrum of the input signal at a particular window of time, the segment shown here represents the window of between 0 and 2 milliseconds (ms). The discrete transformed frequency spectrum may be made up of k number of samples, which are related to the frequencies in the spectrum, thus removing the higher value bins removes the higher frequencies of the transformed audio spectrum and removal of the lower magnitude bins removes frequencies of the transformed audio spectrum with low amplitude.

After discarding the bins, the truncated frequency spectrum data of segments of the input signal is converted from complex number form to polar form, as indicated at 204. As shown in FIG. 3 conversion to polar coordinates changes each complex numbered bin value to polar coordinates with angle θ and an amplitude. Shown here are the mapped polar coordinates for bin 1 303 and bin 2 304 for the frequency spectrum segment of 0-2 ms. In some implementations the amplitude part may be scaled by calculating the maximum amplitude value within the frequency spectrum segment and storing that value with a reference to the segment, other amplitude values are then encoded as a linear scale of the maximum stored amplitude (max) for a segment. By way of example for 8 bit values max would be scaled to values in the range [0; 2⁸−1]=[0;255] and each bin amplitude may then be scaled as amplitude*=(amplitude/255)*max, where max is the stored max amplitude value for the segment and amplitude* is the scaled amplitude value for the specific bin. Additionally, according to some alternative aspects of the present disclosure, during conversion to polar form the polar form spectrum data may be converted from larger 16 bit or 32-bit numbers to 8-bit integers. Converting the 16 bit or 32-bit numbers to 8-bit integers may include truncation and rounding of the 16 bit or 32-bit numbers to fit in the 8-bit number space.

According to some optional aspects of the present disclosure, before conversion of the truncated frequency spectrum data of segments of the input signal, each segment of the truncated frequency spectrum data may be scaled by a scaling factor. The scaling factor may be for example and without limitation a bit shift scaling factor. By way of example, and not by way of limitation, the scaling may be performed using 16-bit integer numbers by converting the data from 32-bit floating point format to 16-bit fixed point format before scaling each input slice. A scaling factor for the operation may be calculated and a next power of 2 may be determined in order to determine the number of bit positions to shift for performing the desired scaling.

Aspects of the present disclosure are not limited to the aforementioned linear scaling to store the quantized magnitudes. In alternative implementations other ways of storing the quantized values might be beneficial. For example, since the magnitudes tend to decay as the frequency decreases, two values could be stored-one at the first bin, and one at the last bin, where the straight line between them would always be at or above the max at any bin. That way we would have better precision as the values get lower and lower. In other alternative implementations the scaling may be non-linear.

Generally, the scaling factor in this implementation may be related to the length of the partition size k and may vary depending on the characteristics of the signal. For example, for an input signal having a pure waveform whose energy is concentrated in a small number of frequency bins, such as a sine wave, a scaling factor of k/2 can be used. Such a scaling factor, when applied to real-world signals whose energy will not be concentrated, would not work well as it would generate a large amount of quantization noise. Normalizing the Input signal spectrum allows use of all the dynamic range offered by 16-bit storage. Since input signals like impulse responses are finite length filters, they can be analyzed offline to determine a precise float scaling factor for the whole file. Similarly, since the other input signals may be infinite in length, one can compute an individual scaling factor for each partition and since that factor is going to be applied in the integer domain after the complex multiplications, one can find the next power of 2 greater than the factor so a shift may be used instead of an integer divide, which is very slow.

At another extreme, for a noisy input signal having energy spread out over a large number of frequency bins, a scaling factor of \sqrt{k} would be more appropriate. In real world applications, the scaling factor selected is likely to be somewhere between these extremes based on the characteristics of each input segment, and it should be selected to find a best fit for the particular signal. It is noted the selection of an appropriate scaling factor is particularly critical when using fixed point format in order to make full use of the range of values that can be represented by the bit width resolution, so as to minimize precision loss.

In order to calculate the best fit for the scaling of each input slice, implementations of the present disclosure can calculate a peak P of the FFT results for each input signal segment. The FFT can be generally scaled to the magnitude of that frequency by finding the next power of 2, which will be called Pₒ. By way of example, and not by way of limitation, scaling of the input slice in 16-bit integer may be performed by a logical shift represented by:

$$Shift = 15 - {log}_{2} ( {P}_{o} )$$

However, this type of truncation would lead to truncation noise due to a consistent bias being applied by the shift. To avoid such truncation noise, implementations according to aspects of the present disclosure may turn a bitwise shift operation into a round-to-nearest by adding a bit right before the shift. This may be accomplished by adding the following bit before performing the above shift:

$$1 << ( shift - 1 )$$

By adding the above bit, shifted to the corresponding location, a subsequent bitwise shift operation that performs the scaling, e.g., an arithmetic right shift, can be converted into a round-to-nearest because the added bit is analogous to adding ½ of the least significant bit after the shift is performed.

It is noted that in the context of the foregoing discussion, the shift is arithmetic because the integer data being shifted is signed data. Referring again to the example of 16-bit signed integer storage of complex data gives us a 15-bit magnitude range (absolute). The complex spectrum values before scaling are dependent on the FFT length which is twice the partition length k, and the nature of the signal (sine versus noise energy distribution). For more information on bit shift scaling see U.S. Pat. No. 9,431,987 to Laurent Betbeder et al.

Once a scaling factor has been determined and segments of the truncated frequency spectrum data of the input signal have been scaled, the scaling factor may be encoded with the spectrum data 207. In some implementations the scaling factor may be stored as a 16 bit integer. In other implementations the scaling factor may be encoded in the topmost amplitude frequency bins after conversion to polar form.

After conversion to polar form, the angle component may be stored as an 8-bit integer and the amplitude component may be stored as an 8-bit integer as indicated at 205. Additionally, in some optional implementations a 16-bit scaling factor may be stored per segment. The 16-bit scaling factor may be encoded with the amplitude component in the highest remaining frequency bin, for example and without limitation one or more frequencies bins at frequencies greater than 29 kHz. In some alternative implementations the angle component may be converted to a 6-bit integer and stored with only little to no loss of fidelity. In some implementations the polar coordinate representation may have a 6-bit angle component instead of 8-bit. In some such implementations, the extra 2-bits that would otherwise be used for the angle component may be used as additional data space for the amplitude component.

Thus, with the above-described method at least a fifty percent decrease in the file size is realized for frequency spectra of input audio signals as compared to the prior art storage of frequency spectra in complex number form. Additionally, the above-described method results in audio which does not sound overly distorted to the human listener when compared to the original signal.

It may be useful to point out some additional details regarding the scaling of the angle component. Since the angles go around the unit circle, they will be periodic within 2π radians. A naïve approach would just quantize the angles to having 2π/255 angles of resolution, but there are problems with this approach. To avoid these problems, it may be useful to “unwrap” the angles and phases. Each angle may be treated as a change of +π or −π from the previous value. This also generally tends to show a decreasing value as the frequencies go higher. The quantization may then approximate the accumulated angle of each increasing frequency bin.

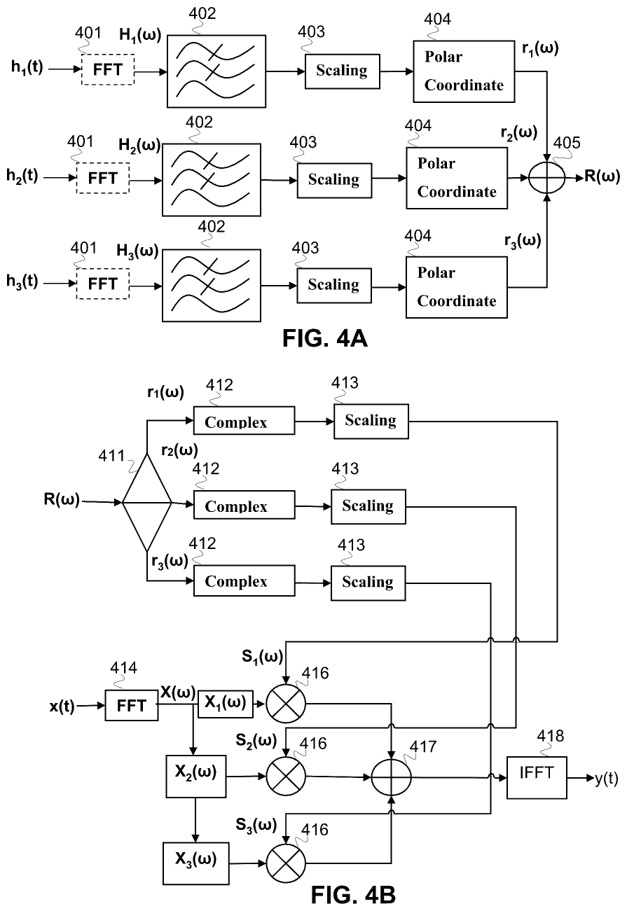

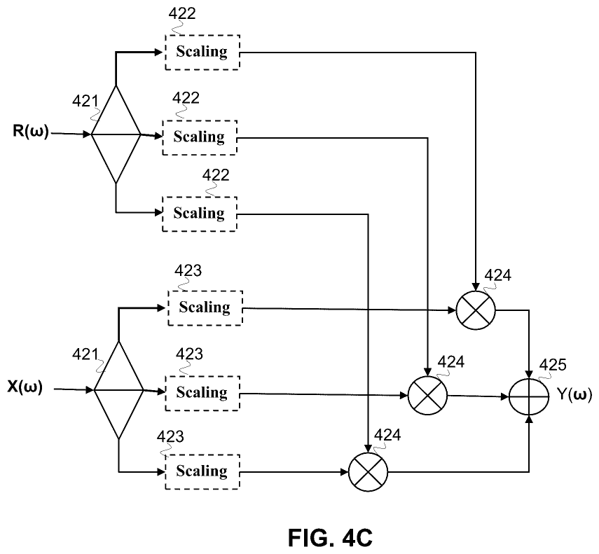

FIG. 4A is a signal flow diagram depicting in detail the method for compression of input signal data according to aspects of the present disclosure. As shown an input signal h(t), such as a Finite Impulse Response, has been uniformly partitioned and segmented into a plurality of time segments h₁(t), h₂(t), and h₃(t) of fixed size k. By way of example, and not by way of limitation, the partition length k may be a number of sampling points in a digitally sampled signal. FFT 401 may optionally be applied to each time segment h₁(t), h₂(t), and h₃(t) of the impulse response function in order to transform the signal from the time domain into the frequency domain and generate a corresponding frequency spectrum, H₁(ω), H₂(ω) H₃(ω), for each time segment. In some implementations the partitioned and segmented input signal data may already be in the frequency domain and in such cases application of FFT would be unnecessary. The inputs to the FFT, 401 may be zero-padded in order to avoid drawbacks associated with circular convolution A low pass filter is applied to the frequency spectrum, H₁(ω), H₂(ω) H₃(ω), for each time segment to remove the high frequency bins from the spectrum to generate a truncated frequency spectrum for each time segment. As discussed above, the high frequency bins correspond to frequencies that are inaudible to normal humans for example and without limitation frequencies greater than 28 kHz. The truncated frequency spectrum for each time segment is then scaled at 403 via for example and without limitation a bit shift scaling factor as discussed above. The scaled truncate frequency spectrum data for each time segment is finally converted from complex number form to polar form 404. The polar form data may be truncated and, in some cases, rounded to fit into an 8-bit number space. In some alternative implementations the angle value may be further truncated and, in some cases, rounded to fit a 6-bit number space. The Polar form truncated frequency spectrum data for each time segment is then accumulated at 405 to generate a complete compressed frequency spectrum data for the input signal R(ω).

FIG. 4B is a signal flow diagram depicting a method for convolution of compressed input signal data with another input signal according to aspects of the present disclosure. The compressed frequency spectrum data for the input signal R(ω) is a first input signal for this method. The compressed frequency spectrum data for the input signal R(ω) is segmented 411 into frequency spectrum data of time segments of the input signal r₁(ω), r₂(ω), r₃(ω). The frequency spectrum data of time segments of the input signal are then converted from polar form to complex number form 412. This conversion may be performed by for example and without limitation the use of trigonometric functions with the amplitude (θ) and angle (r) to solve for the real parts (x) and imaginary parts (y). These functions may be:

$$y = r sin θ$$

$$x = r cos θ$$

After conversion if a scaling factor was applied the frequency spectrum data of time segments of the input signal in complex number form may be scaled by the scaling factor at 413. The scaled frequency spectrum data in complex number form, S₁(ω), S₂(ω), S₃(ω) may then be used as an input for the convolution operation.

A second input signal x(t) may be prepared for the convolution. The input signal x(t) may be uniformly partitioned and segmented into a plurality of time segments and converted from a time domain by application of FFT 414 to generate frequency domain spectrum of time segments of the input signal X(ω) As discussed above in some implementations the input signal data may already be in the frequency domain and in which case application of FFT is not necessary. The frequency domain spectrum of the input signal may be made up of corresponding time segments x₁(ω), x₂(ω) x₃(ω). The inputs to the FFT, 414 may be zero-padded in order to avoid drawbacks associated with circular convolution. An appropriate scaling factor may also be applied to FFTs to scale the Fourier coefficients of the FFTs 414 as needed. Additionally, the scaling factor 413 may be adjusted to suitably match the FFT coefficients of the second input signal x₁(ω), x₂(ω) x₃(ω).

According to aspects of the present disclosure, the scaling of the other input signal FFT coefficients may be handled differently from the scaling of Impulse Response (IR) FFT coefficients. By way of example, and not by way of limitation, the IR FFT coefficients may be scaled (as a whole) by a single floating-point normalizer to a −32 k+32 k range (fixed point 1:15 normalization) to maximize the dynamic range and allow IR crossfading at runtime. The input signal FFT coefficients may be scaled by a power of 2 factor per partition, which allows fast integer denormalization via a right shift and provides headroom to accumulate in 32 bit integer.

Complex point-wise multiplication at 416 may then be performed between the frequency domain spectrum of time segments of the second input signal x₁(ω), x₂(ω) x₃(ω) and the scaled frequency spectrum data in complex number form of the first input signal, S₁(ω), S₂(ω), S₃(ω) for each corresponding time segment. These results may further be scaled to produce a desired signal and then the time segments of the resulting spectrums may be accumulated as indicated at 417. After accumulation, an IFFT 418 may be performed on the accumulated data to transform the signal from the frequency domain into the time domain and generate the desired time domain signal y(t). By way of example, and not by way of limitation, the output signal y(t) may be a synthesized sound for a real-time input stream of sounds that includes the acoustic effect of an environment on the input signal x(t).

FIG. 4C is a signal flow diagram depicting a method for convolution of compressed input signal data with the data of another compressed input signal according to aspects of the present disclosure. As shown the method for convolution of compressed input signal data with the data of another compressed input signal includes a compressed frequency domain spectrum data of a first input signal R(ω) and compressed frequency domain spectrum data of a second input signal X(ω). Both spectra R(ω) and X(ω) are in polar form. The compressed frequency domain spectra are comprised of time segments of the input signal which may be separated as indicated at 421. The separated time segments of frequency domain spectrum data of a first input signal may (optionally) be scaled 422 to place it in the appropriate scale for convolution with a second input signal. Similarly, the separated time segments of frequency domain spectrum data of a second input signal may (optionally) be scaled at 423 to place it in the appropriate scale for convolution with the first input signal. After scaling, the scaled frequency domain spectrum for each time segment of the first input signal may be point wise multiplied 424 with the corresponding time segment of the frequency domain spectrum of the second input signal in polar form to convolve the two spectra.

To multiply a simple transformation between the points in the spectra may be performed by multiplying the amplitudes of corresponding points in the spectra and addition of the angles in the trigonometric function as shown below where hᵣ_{₁}_{(ω)} represents an amplitude of a bin in a time segment of the frequency spectra of the first input signal r₁(ω) and hₓ_{₁}_{(ω)} represents an amplitude of a bin in a time segment of the frequency spectra of the second input signal x₁(ω). θᵣ_{₁}_{(ω)} represents an angle of a bin in a time segment of the frequency spectra of the first input signal r₁(ω) and θₓ_{₁}_{(ω)} represents an angle of a bin in a time segment of the frequency spectra of the second input signal x₁(ω).

$${h}_{{r}_{1} ( ω )} * {h}_{{x}_{1} ( ω )} = {h}_{c ( ω )}$$

$${θ}_{{r}_{1} ( ω )} + {θ}_{{x}_{1} ( ω )} = {θ}_{c ( ω )}$$

h_{c(ω)} is the resulting amplitude bin value of the multiplied points and θ_{c(ω)} is the resulting angle.

After the two spectra in polar form are subjected to point wise multiplication at each time segment, the resulting spectra may be accumulated 425 to generate convolved signal data in polar form. This convolved signal may be converted to complex number form and converted to the time domain via IFFT. The time domain signal may be for example and without limitation a synthesized sound for a real-time input stream of sounds that includes the acoustic effect of an environment on the input signal as discussed above.

Here the above-described methods may provide at least a 50% decrease in the amount of storage space required to store frequency spectra of input signals over prior art storage methods. Additionally, the above-described methods may allow convolution operations to be performed on the compressed frequency domain spectra in polar form.

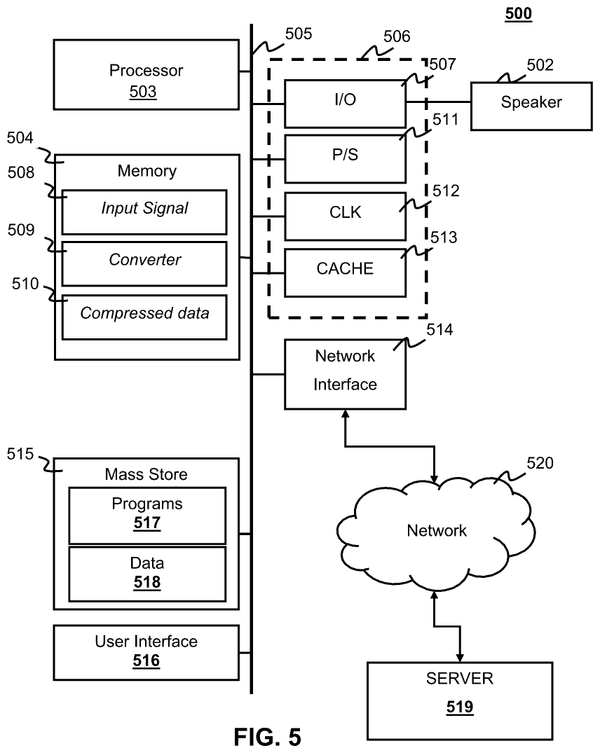

FIG. 5 depicts an example of a system 500 for implementing compression of input signal data according to aspects of the present disclosure. The system may include a computing device 501 coupled to a speaker 502.

The computing device 501 may include one or more central processing units (CPU) and/or one or more graphical processing units (GPU) 503, which may be configured according to well-known architectures, such as, e.g., single-core, dual-core, quad-core, multi-core, processor-coprocessor, cell processor, and the like. The computing device may also include one or more memory units 504 (e.g., random access memory (RAM), static random-access memory (SRAM), dynamic random-access memory (DRAM), read-only memory (ROM), and the like). The computing device may optionally include a mass storage device 515 such as a disk drive, CD-ROM drive, tape drive, flash memory, solid state drive (SSD) or the like, and the mass storage device may store programs and/or data.

The processor unit 503 may execute one or more programs, portions of which may be stored in memory 504 and the processor 503 may be operatively coupled to the memory, e.g., by accessing the memory via a data bus 505. The programs may be configured to implement a method for compression of input signal data as described above, for example in FIG. 2, with a converter application 509. These programs may be part of the platform's operating system or may be standalone programs or services. The memory may include data utilized by the operating system or programs carrying out the method for compression of frequency spectrum data corresponding to Input signals 508. The converter application may include one or more algorithms for transforming the Input signal data 508 from a time domain to a frequency domain and conversion of the complex numbers to coordinate form. The memory may additionally include the compressed input signal data 510 resulting from the compression method.

The computing device 501 may also include well-known support circuits, such as input/output (I/O) 507, circuits, power supplies (P/S) 511, a clock (CLK) 512, and cache 513, which may communicate with other components of the system, e.g., via the data bus 505. The computing device may include a network interface 514 to facilitate communication with other devices. The processor 503 and network interface 514 may be configured to implement a local area network (LAN), personal area network (PAN), Wide area network (WAN), and/or communicate with the internet, via a suitable network protocol, e.g., Bluetooth, for a PAN. The computing device 501 may also include a user interface 516 to facilitate interaction between the system and a user. The user interface may include a display screen, a keyboard, a mouse, microphone, a light source and light sensor or camera, a touch interface, game controller, or other input device.

The network interface 514 facilitates communication via an electronic communications network 520. The network interface 514 may be configured to facilitate wired or wireless communication over LAN, PAN, and/or the internet to trigger actions in network connected devices. The system 500 may send and receive data via one or more message packets over the network 520. Message packets sent over the network 520 may temporarily be stored in a buffer in memory 504.

Compression of complex number audio signal data by conversion from real and imaginary components to polar coordinates can greatly reduce the amount of data that needs to be stored or transmitted without detrimentally affecting audio quality. This is particularly useful in situations involving convolution of an input signal with a reverb or room response signal for applications such as video games.

While the above is a complete description of the preferred embodiment of the present invention, it is possible to use various alternatives, modifications, and equivalents. Therefore, the scope of the present invention should be determined not with reference to the above description but should, instead, be determined with reference to the appended claims, along with their full scope of equivalents. Any feature described herein, whether preferred or not, may be combined with any other feature described herein, whether preferred or not. In the claims that follow, the indefinite article “A,” or “An” refers to a quantity of one or more of the item following the article, except where expressly stated otherwise. The appended claims are not to be interpreted as including means-plus-function limitations, unless such a limitation is explicitly recited in a given claim using the phrase “means for.”

What is claimed is:

1. A method for compression of input signal data, comprising:
a) converting frequency spectrum data of a segment of a input audio signal from complex number form having a high bit count real and imaginary parts to polar coordinate form having a lower bit count angles and amplitudes;
b) storing frequency spectrum of the segment of the input audio signal in the polar coordinate form wherein storing the frequency spectrum of the segment of the input signal in polar coordinate form requires less bits than storing the frequency spectrum data of the segment of the input signal in complex number form.

2. The method of claim 1 further comprising removing high frequency bins from the frequency spectrum data of the segment of the input audio signal, wherein the high frequency bins correspond to frequencies that are imperceptible to humans.

3. The method of claim 2 further comprising scaling the frequency spectrum data of the segment of the input audio signal by a scaling factor and storing the scaling factor in a high frequency bin of the frequency spectrum data of the segment of the input signal after the high frequency bins are removed.

4. The method of claim 1 further comprising scaling the frequency spectrum data of the segment of the input audio signal by a scaling factor.

5. The method of claim 1 further comprising transforming the segment of the input audio signal from a time domain to a discrete frequency domain to generate the frequency spectrum data of the segment of the input audio signal and wherein the frequency spectrum data is in complex number form.

6. The method of claim 5 wherein the transforming the segment of the input audio signal includes applying Discrete Fourier Transform to the input audio signal.

7. The method of claim 1 wherein the input audio signal is an impulse response signal.

8. The method of claim 1 further comprising convolving the frequency spectrum data of the segment of the input audio signal in polar coordinate form with frequency spectrum data of a segment of a second audio signal in polar coordinate form to generate a convolved signal of the impulse response signal and the second audio signal.

9. The method of claim 1 further comprising converting the frequency spectrum data of the segment of the input audio signal from a 32-bit format to 16-bit format before conversion to the polar coordinate form.

10. The method of claim 1 wherein the complex number form having a high bit count real and imaginary parts includes 16-bit or more real parts and 16-bit or more imaginary parts.

11. The method of claim 1 wherein the polar coordinate form includes 8-bit or less angles and 8-bit or less amplitudes.

12. The method of claim 11 wherein the polar coordinate form further includes a 16 bit per segment scaling factor.

13. The method of claim 11 wherein the angles are 6-bit integers.

14. The method of claim 1, wherein one or more of the angles is treated as a change of +π or −π from a previous angle value.

15. The method of claim 1, wherein for a sequence of bins of the frequency spectrum, amplitude values for which decay as the frequency decreases, storing the frequency spectrum includes storing a first value at a first bin of the sequence of bins, and storing a second value at a last bin of the sequence of bins, whereby a straight line between the first value and the last value is at or above the maximum value at any bin in the sequence of bins.

16. The method of claim 1 further comprising converting the frequency spectrum of the segment of the input audio signal in polar coordinate form to complex number form and convolving the frequency spectrum of the segment of the input audio signal in complex number form with a frequency spectrum of a segment of a second audio signal in complex number form.

17. A system comprising:
a processor;
a memory coupled to the processor;
program instructions embodied in the memory an executable by the processor, wherein execution of the program instructions by the processor causes the processor to implement a method, the method comprising:
a) converting frequency spectrum data of a segment of a input audio signal from complex number form having a high bit count real and imaginary parts to polar coordinate form having a lower bit count angles and amplitudes;
b) storing frequency spectrum of the segment of the input audio signal in the polar coordinate form wherein storing the frequency spectrum of the segment of the input in polar coordinate form requires less bits than storing the frequency spectrum data of the segment of the input audio signal in complex number form.

18. The system of claim 17 further comprising a speaker and wherein the program instructions further include converting the frequency spectrum of the segment of the input signal in polar coordinate form back to complex number form, applying an inverse transform to the frequency spectrum of the segment of the input signal in complex number form to reconstruct time domain data of the segment of the input audio signal and playing the reconstructed time domain data of the segment of the input audio signal with the speaker.

19. The system of claim 17 wherein the program instructions further include removing high frequency bins from the frequency spectrum data of the segment of the input audio signal, wherein the high frequency bins correspond to frequencies that are imperceptible to humans.

20. The system of claim 17 wherein the program instructions further include scaling the frequency spectrum data of the segment of the input audio signal by a scaling factor.

21. The system of claim 17 wherein the program instructions further include transforming the segment of the input audio signal from a time domain to a discrete frequency domain to generate the frequency spectrum data of the segment of the input audio signal and wherein the frequency spectrum data is in complex number form.

22. A non-transitory computer readable medium having program instructions, wherein execution of the program instructions by one or more processors causes the one or more processors to perform a method, the method comprising:
a) converting frequency spectrum data of a segment of a input audio signal from complex number form having a high bit count real and imaginary parts to polar coordinate form having a lower bit count angles and amplitudes;
b) storing frequency spectrum of the segment of the input audio signal in the polar coordinate form wherein storing the frequency spectrum of the segment of the input signal in polar coordinate form requires less bits than storing the frequency spectrum data of the segment of the input audio signal in complex number form.
